(19) United States
(12) Patent Application Publication
(10) Pub. No.: US 2005/0137447 A1
(43) Pub. Date: Jun. 23, 2005

(54) Acoustic sensor for an implantable hearing aid

(76) Inventor: Armin Bernhard, Wien (AT)

Correspondence Address: CANTOR COLBURN, LLP, 55 GRIFFIN ROAD SOUTH, BLOOMFIELD, CT, 06002, US

(21) Appl. No.: 10/508,806

(22) PCT Filed: Mar. 20, 2003
(86) PCT No.: PCT/DE03/00919

(30) Foreign Application Priority Data
Mar. 21, 2002 (DE) 102 12 726.3

(51) Int. Cl. H04R 25/00

(52) U.S. Cl. 600/25

(57) ABSTRACT

Sound receiver for an implantable hearing aid, in particular for a cochlea implant, where the sound receiver is an implantable electromechanic transducer, which converts the force resulting of an accelerated mass into an electric signal. The sound receiver provides a mounting mechanism on at least one of the ossicles in the ossicle chain.

This patent specifies a sound receiver for an implantable hearing aid.

Due to the rapid improvement in cochlea implants (CI) in recent years, aurally handicapped and deaf patients have the chance to completely regain their ability to hear and understand human speech. Cochlea implants take over the functions of the outer, middle and inner ear, whereas middle ear prostheses merely improve and support the ear's function. CI's strive to reproduce the typical frequency selectivity, amplitude resolution and dynamic range of the healthy ear. This way the disturbed signal processing between the auricle and the audio cortex is reconstructed.

Essentially cochlea prostheses consist of two parts which are connected transcutaneously by a wireless transmission line: an external device and an implanted part. The external device is usually carried behind the ear containing microphone, signal processor, transmitter and power supply. Here the input signal is processed and output patterns are calculated, using individually determined stimulus parameters for each patient. The inner or implanted part contains a receiver to pick up the electrical stimulation signal and an electrode array which is implanted into the cochlea to stimulate the auditory nerve with electrical pulses.

Since most CI-users have a fully intact outer and middle ear, the intact existing parts of the hearing system should be used to improve the sound transduction and allow for a better signal/noise ratio.

Usage of the ear's natural anatomy promises an improvement of sound quality. Social problems can be reduced by using fully implantable cochlea prosthesis instead of avoiding an external processor unit. The sound transduction using a fully implantable microphone is one of the biggest challenges.

Today two sorts of fully implantable microphones for middle ear prosthetic use are known. The first method utilizes a common airborne sound microphone, which is implanted beneath the skin either behind the ear or inside the auditory canal. The second method utilizes piezoelectric characteristics of materials, which allow flexural wave propagation. The sensor is fixed to the tympanic cavity and rigidly connected to the malleus. When the tympanic membrane (which on its part is connected to the malleus) is moved, the correspondent movement of the malleus which is proportional to the originating sound signal is measured by using the piezoelectric element (U.S. Pat. No. 5,889,847). The disadvantage of this technique is, however, that the incus has to be removed from the middle ear in order to ensure the fixing of the sensor.

Despite the miniaturization of external (carried behind the ear) processors, CI-users still suffer from their handicap, since the usage of the external part compromises the flexibility of body movement e.g. in sports. Children find this problem most severe. In many cases that can lead to social isolation. Another aspect is that teenagers reject to wear their CI, as the external part remains visible and indicates their handicap.

The invention as described below defines now an easy to implant sound receiver, which makes use of the intact outer and middle ear. The essential difference to the already known approaches is that the sound receiver is mechanically connected to one of the ossicles (malleus, incus and stapes) in order to measure the acceleration of the connected ossicle. The connector itself is designed to be low in weight and yet to provide a rigid connection to one of the ossicles in the ossicle chain. The impedance transforming function of the ossicle chain allows an improved way of sound transduction by picking up the acceleration of the oscillating parts. The excitation signal can be derived from these inputs. To do so, a highly sensitive and miniaturized electroacoustic transducer is needed in a frequency range between 300 Hz and 8 kHz.

It has to be considered, that, depending on mass and geometry of the sensor, which is fixed to one of the ossicles, the sensor's moment of inertia influences the ossicle's freedom of movement. Due to the low mass of the ossicles (malleus: approx. 25 mgs, incus: approx. 28 mgs, stapes: approx. 3 mgs) the sensor should not exceed 100 mgs, but preferably be between 20 and 50 mgs.

Furthermore it has to be considered, that there is very little space in the middle ear and the geometric dimensions of the ossicles are very small (malleus: length 8 mm, angle between head and manubrium 140°, incus: length of crus breve: 5 mm, length of crus longum: 7 mm, included angle 100°, stapes: height 3.5 mm, base length 3 mm, width 1.4 mm, base area 3 mm²). This requires a maximum sensor height of 5 mm and a width of not more than 5 mm. The geometrical shape is not of major importance. A homogeneous cylinder as well as a rectangular shape may be used.

The sensor's direction of sensitivity can be chosen arbitrarily for example in longitudinal or transversal direction, corresponding to the ossicle chains movement. As acceleration is being measured, the acceleration sensor doesn't need to be fixed additionally to bones or anywhere else. The sole connection needed is to one of the ossicles. Of special importance is the advantage to completely enclose the sensor. All relative motion occurs inside the hermetic housing. Relative movement between two parts of the sensor (as in U.S. Pat. No. 5,899,847) does not occur.

In order to transduce the sound no additional system component is necessary. Due to the rapid development of semiconductor technology, a miniaturized impedance and/or A/D converter can be integrated in the small housing. With such a converter the recorded analog signals can be transmitted digitally which significantly reduces the sensitivity to electromagnetic disturbances. The connection between the acceleration probe and the signal processing unit of the CI or implantable hearing aid should be achieved using ultra-thin wires with low masses and highly elastic properties for a minimum influence on the ossicles.

The acceleration sensor can be glued to one of the ossicles or clipped to it. Likewise the sensor could be clipped to the umbo, a depressed area of the tympanic membrane. Despite the fact that this would damage the tympanic membrane, the resulting injury should heal within a reasonable time.

Furthermore it has to be noticed that neither bones of the ossicles need to be removed (as in U.S. Pat. No. 5,889,847) nor additional surgery is necessary to attach the converter during the CI implantation, as the middle ear has to be opened for the cochlea electrode insertion anyway.

According to the patent the acceleration probe has an air tight, sealed housing. Inside there is a vibratory device such as a semiconductor film, a leaf spring or a flexible plate etc. Preferably a small mass, which is moved by the acceleration forces, is to be fixed to the described vibratory structure at that point, which allows for the largest possible elongation. Using a clamped leaf spring such a mass can be omitted.

Further advantages and characteristics arise from the following claims as well as description of examples and applications (which are not to be understood as limiting). These examples and applications are explained in the images as follows:

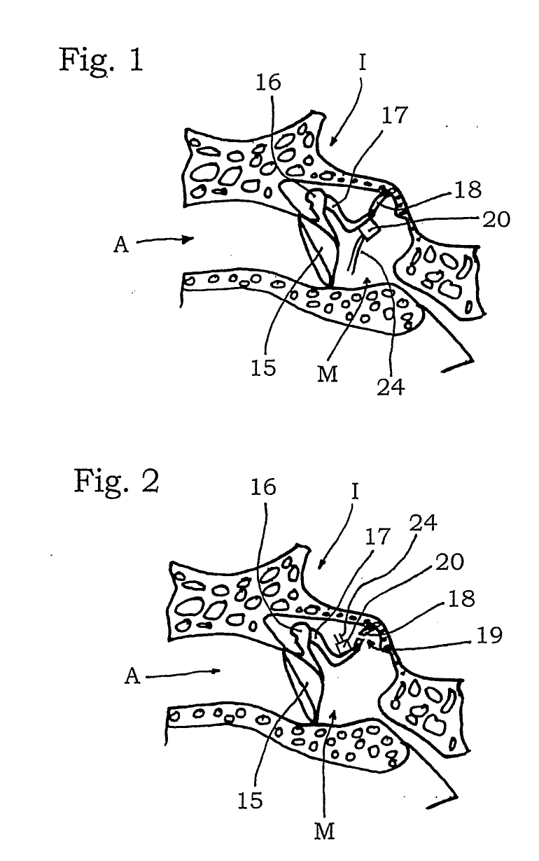

FIG. 1: A sectional view of an ear. Illustrated is external ear (A), middle ear (M). The inner ear (I) is suggested. Shown is an acceleration probe, firmly connected to the incus.

FIG. 2: Illustration such as FIG. 1, but with a disconnection between incus and stapes.

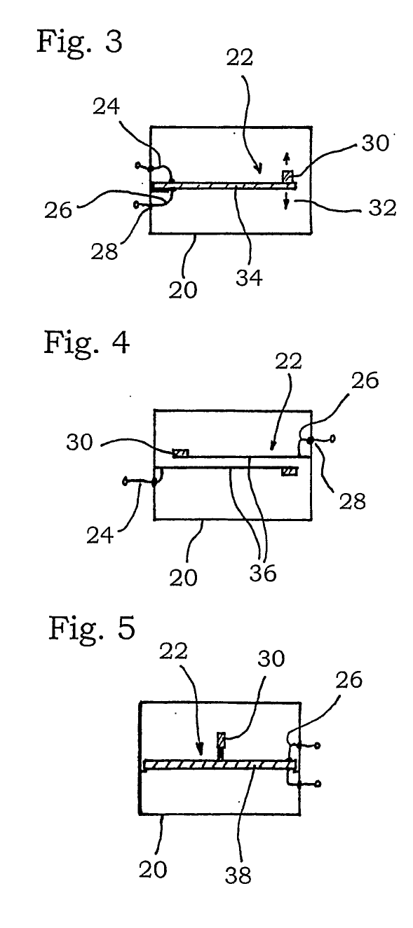

FIG. 3: Illustration of the principles of an acceleration probe, showing a one-sided clamped leaf spring made of piezoelectric material.

FIG. 4: Illustration similar to FIG. 3, but for a capacitive configuration.

FIG. 5: Illustration similar to FIG. 3, but with a piezoelectric plate, which is two-side clamped and able to oscillate within the central range.

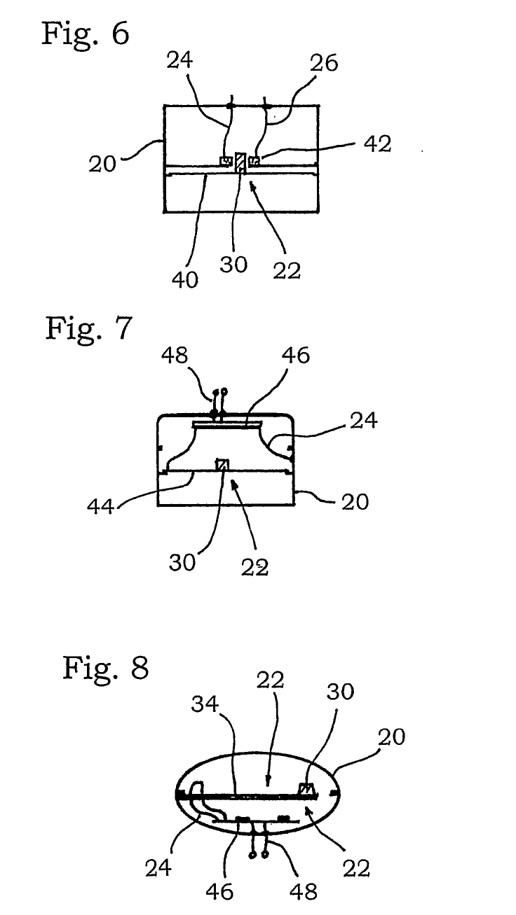

FIG. 6: Illustration similar to FIG. 3, but with a permanent magnet, which is located in a gap of a stationary coil, attached to a clamped thin foil.

FIG. 7: Cross section through an acceleration probe with a piezoelectric foil and the dedicated electronics.

FIG. 8: Cross section through an acceleration probe with a one-sided clamped piezoelectric foil and electronics.

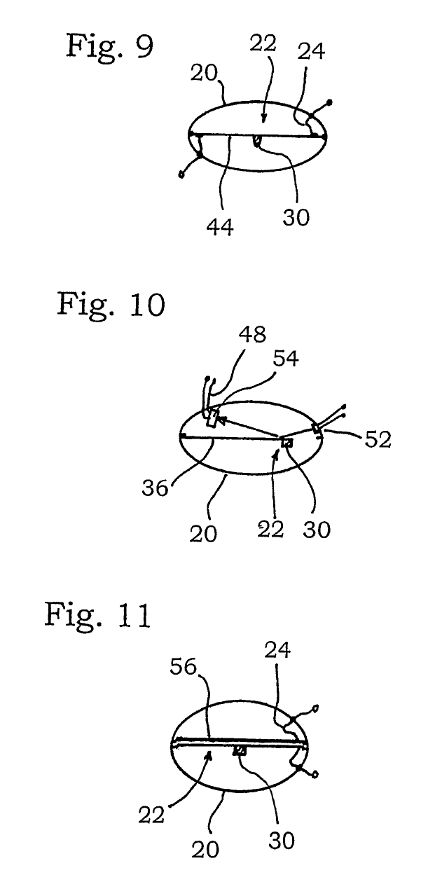

FIG. 9: Cross section similar to FIG. 8 with a mass attached in the center of a two-sided clamped piezoelectric foil.

FIG. 10: Illustration similar to FIG. 8, but with optical sampling of the oscillation.

FIG. 11: Illustration similar to FIG. 8, but with capacitive measurement of the mass oscillation.

FIGS. 1 and 2 show the tympanum 15 and the ossicles malleus 16, incus 17 and stapes 18. At the incus 17 the acceleration probe is fixed. It has a hermetic air tight housing 20 made of biocompatible material, for instance a thin gold foil or titanium sheet. It is also possible to use a plastic housing, which is conductively coated or vaporized inside in order to establish a Faraday's cage. In the housing 20 there is a structure 22, which is able to oscillate and can be implemented arbitrarily. The housing 20 is bipartite and typically it is constructed of two half shells, which are overlapping or in any other form closing tight.

In FIG. 2 incus 17 and stapes 18 are disconnected at the gap 19. Thus approximately a tenfold magnification of the amplitude is achieved by the incus' 17 movement due to sound.

In the example of FIG. 3 the structure 22, which is able to oscillate, is a one-sided fixed leaf spring 35 made of piezoelectric material, here ceramics, namely barium titanate. On both opposite major sides electrodes are attached. The feed lines 24, 26 are lead through 28 the housing 20. At the free end of the leaf spring 35 made of piezoceramic a mass 30 is attached. A change of acceleration causes a movement in the direction of the arrows 32. Thus the piezoceramic is distorted and a signal can be measured at the feed lines 24.

In the example of FIG. 4 the vibratory structure consists of two thin identical leaf springs 36, which are made of thin metal or metalized plastic. At their free ends each of them has a mass 30. Both leaf springs form two plates of a capacitor. By movement of the two masses caused by a change of the acceleration the distance of the two plates of the capacitor varies. Due to the changing capacity of the capacitor an electrical signal can be measured at the feed lines 24, 26.

In FIG. 5 a mass 30 is attached in the center of a two-sided clamped piezoelectric plate 38. This mass can oscillate in the direction of the arrows 32 as shown in the previous examples. The upper and the lower surface of the piezoelectric plate 38 are connected with electrodes, the feed lines 24, 26 of which are lead out 28. A change of the acceleration causes a change of the plate's 38 distortion, thus originating a signal, which is lead off via the feed lines 24, 26.

In FIG. 6 a thin foil 40, for example a 20 μm PTFE-foil is two-sided clamped carrying a permanent magnet as mass 30 in its center. The foil and the magnet are building the vibratory structure 22. The nib-shaped permanent magnet is surrounded by a coil 42, which is fixed to the housing 20. A motion of the vibratory structure 22 induces voltage in the coil 42.

FIG. 7 is similar to FIG. 5; however, instead of the piezoelectric plate 38 a piezoelectric foil 44, for instance PVDF Polyvinylidene Fluoride is used. In its center it carries a small mass 30, both together form the vibratory structure 22. The foil 44 is metalized on both sides. The upper side is in contact with the feed line 24 and the lower side is via the metallic housing 20 connected to the line feed 26. Both feed lines 24, 26 are led to a circuit 46, where an A/D-conversion and an impedance transformation take place. The result is led off by the outer feed lines 48.

In the example of FIG. 8 the housing 20 has an ellipsoid form, which is also used from FIG. 9 to FIG. 11. The housing 20 is bipartite again and separated at the level of the largest diameter. FIG. 8 shows a realization, similar to FIG. 3, but the ceramic leaf spring 34 in FIG. 3 is replaced by a strip of piezoelectric plastic like PVDF. On both sides electrodes are attached. They are connected with the feed lines 24, 26 and led through 28 the housing 20 to a circuit 46, where the impedance transformation is carried out. The result is led off by the outer feed lines 48.

In the example of FIG. 9 a plastic foil similar to FIG. 7 is two-sided clamped, but directly connected with two feed lines 24, 26. A centrally attached mass 30 is intended.

In FIG. 10 a light leaf spring 36 is one-sided clamped. On the one side it carries a mass 30, on the other side it is reflecting. A light source 52, a LED for example, is pointed towards the reflecting surface. The light's fine ray reflection is depended on the deflection of the plate-formed leaf spring. The reflected light beam, containing the sound information, is picked up by a receiver 54, where the signal is measured.

In FIG. 11 finally, a capacitive acceleration probe is represented showing two opposing, conducting or conductively coated plates. The lower plate, realized by a thin, metalized foil and a mass 30 in the center of the plate is representing a vibratory structure. The upper plate is substantially rigid. By accelerating the mass 30 the lower, foil-like plate is distorted, thus changing the gap between the plates and the capacity. Favorably an electronic circuit 46 is planned inside the housing 20, to keep the output low-resistance.

The mass 30 is in a range of a few milligrams for example 5 mgs or 10 mgs. Basically the acceleration probe is implemented as lightweight as possible.

1. Sound receiver for an implantable hearing aid, comprising a sound receiver being an implantable electromechanic transducer, which converts the force resulting of an accelerated mass into an electric signal, the sound receiver provides a mounting mechanism on at least one of the ossicles in the ossicle chain.

2. Sound receiver of claim 1, wherein the transducer is selected from the group consisting of a piezoelectric transducer, a particularly resonance frequency transducer, foil oscillatory, a magnetostrictive transducer, a capacitive transducer and, an inductive transducer.

3. Sound receiver of claim 1, wherein the electromechanical transducer comprises a biologically compatible surface.

4. Sound receiver of claim 1, wherein the sound receiver is housed in a metallic conductive housing.

5. Sound receiver of claim 4, further comprising an A/D-converter and an impedance transformer placed inside the housing.

6. Sound receiver of claim 1, further comprising a mounting mechanism adapted to one of the following ossicles: malleus, incus and/or stapes.

7. Sound receiver of claim 1, wherein an entire mass of the sound receiver is less than 50 milligrams.

8. Sound receiver of claim 1, further comprising a vibratory structure exclusively placed inside a housing.

9. Usage of a sound receiver of claim 1, comprising a sound receiver rigidly fixed to malleus or incus, whereby incus and stapes are disconnected so that the incus can move independently from the stapes.

10. Sound receiver of claim 1, wherein the sound receiver is destined for a Cochlea implant.

11. Sound receiver of claim 3, wherein the hermetic housing is made of a biologically compatible material.

12. Sound receiver of claim 1, wherein an entire mass of the second receiver is below 30 milligrams.
